(19) United States
(12) Patent Application Publication
(10) Pub. No.: US 2015/0326321 A1
(43) Pub. Date: Nov. 12, 2015

(54) OPTICAL TRANSMISSION AND RECEPTION APPARATUS AND METHOD FOR UPLINK TRANSMISSION IN ORTHOGONAL FREQUENCY DIVISION MULTIPLE ACCESS-PASSIVE OPTICAL NETWORK (OFDMA-PON)

(71) Applicant: ELECTRONICS AND TELECOMMUNICATIONS RESEARCH INSTITUTE, Daejeon (KR)

(72) Inventors: Seung Hyun CHO, Daejeon (KR); Kyeong Hwan DOO, Daejeon (KR); Hun Sik KANG, Daejeon (KR); Jie Hyun LEE, Daejeon (KR)

(21) Appl. No.: 14/698,025

(22) Filed: Apr. 28, 2015

(30) Foreign Application Priority Data
May 9, 2014 (KR) 10-2014-0055811

(51) Int. Cl. H04B 10/556; H04L 27/26

(52) U.S. Cl. CPC H04B 10/556; H04L 27/2627

(57) ABSTRACT

Provided is an optical transmission apparatus and method for uplink transmission in an orthogonal frequency division multiple access-passive optical network (OFDMA-PON), wherein the optical transmission apparatus includes a digital signal processor to output a baseband orthogonal frequency division multiplexing (OFDM) signal, a tone generator to generate a dithering tone, a synthesizer to synthesize the dithering tone and the baseband OFDM signal, and an optical source to output an output light in which a spectrum width is increased to be greater than a spectrum width of a carrier light based on the baseband OFMD signal synthesized with the dithering tone.

### CROSS-REFERENCE TO RELATED APPLICATION

This application claims the priority benefit of Korean Patent Application No. 10-2014-0055811, filed on May 9, 2014, in the Korean Intellectual Property Office, the disclosure of which is incorporated herein by reference.

### BACKGROUND

1. Field of the Invention

The present invention relates to an optical transmission apparatus and method for uplink transmission in an orthogonal frequency division multiple access-passive optical network (OFDMA-PON), and more particularly, to an apparatus and a method for preventing or reducing deterioration of transmission performance that may be caused by optical beat interference (OBI) noise occurring in uplink transmission by increasing a spectrum width of an output light in an OFDMA-PON.

2. Description of the Related Art

Orthogonal frequency division multiple access-passive optical network (OFDMA-PON) technology applies an orthogonal frequency division multiplexing (OFDM) modulation and a multiplexing method resistant to signal distortion that may be caused by optical fiber dispersion and the like. The OFDMA-PON technology may be an economically affordable optical networking technology that may be simply achieved through a digital signal processing method. In addition, the OFDMA-PON technology may transparently process all services using the OFDM. Further, the OFDMA-PON technology may maintain network flexibility while providing a very narrow unit bandwidth to a subscriber based on an OFDM subcarrier. Furthermore, the OFDMA-PON technology may be acceptable without alterations to a time division multiplexing-passive optical network (TDM-PON) based optical distribution network that has already been distributed.

Conventional OFDMA-PON technology applies optical transmission that uses intensity modulation and direct detection methods to economically construct an OFDMA-PON. However, when the intensity modulation and the direct detection methods are used in upstream transmission for which a single wavelength is used, an output light transmission quality may deteriorate due to an occurrence of an optical beat interference (OBI) noise component corresponding to a difference in normal wavelengths between optical sources in an optical reception apparatus of an optical line terminal (OLT) that receives an output light.

Accordingly, there is a desire for a method of avoiding or reducing deterioration in the output light transmission quality.

### SUMMARY

An aspect of the present invention provides an apparatus and a method for avoiding or reducing deterioration in transmission performance that may be caused by optical beat interference (OBI) noise occurring in uplink transmission in an orthogonal frequency division multiple access-passive optical network (OFDMA-PON) uplink in which a plurality of independent optical network unit (ONU) optical sources use a single wavelength band.

According to an aspect of the present invention, there is provided an optical transmission apparatus that outputs an output light by modulating a carrier light based on a baseband orthogonal frequency division multiplexing (OFDM) signal, and increases a spectrum width of the carrier light or a spectrum width of the output light.

The optical transmission apparatus may include a digital signal processor to output the baseband OFDM signal, a tone generator to generate a dithering tone, a synthesizer to synthesize the dithering tone and the baseband OFDM signal, and an optical source to output the output light in which the spectrum width is increased to be greater than the spectrum width of the carrier light based on the baseband OFDM signal synthesized with the dithering tone.

In the optical transmission apparatus, a frequency of the dithering tone may be greater than an overall bandwidth of the baseband OFDM signal and smaller than a modulation bandwidth of the optical source.

The optical source may generate the output light by generating the carrier light based on a wavelength or a frequency band pre-allocated to the optical transmission apparatus, increasing the spectrum width of the carrier light using the dithering tone, and modulating the carrier light in which the spectrum width is increased based on the baseband OFDM signal.

The optical transmission apparatus may include a digital signal processor to output the baseband OFDM signal and an external modulator to output the output light by modulating the carrier light in which the spectrum width is increased to be greater than a default value based on the baseband OFDM signal.

The optical transmission apparatus may further include an optical source to generate the carrier light based on a wavelength or a frequency band pre-allocated to the optical transmission apparatus, increase the spectrum width of the carrier light using a dithering tone, and output the carrier light in which the spectrum width is increased.

The optical transmission apparatus may include a digital signal processor to output the baseband OFDM signal, a reflective modulator to output the output light by modulating the carrier light in which the spectrum width is increased to be greater than a default value based on the baseband OFDMA signal, and an optical circulator to change a path of the carrier light in which the spectrum width is increased to allow the carrier light in which the spectrum width is increased to be incident to the reflective modulator, and change a path of the output light to output the output light.

The optical transmission apparatus may include an optical source to output the carrier light based on a wavelength or a frequency band pre-allocated to the optical transmission apparatus, a phase modulator to output the carrier light in which the spectrum width is increased to be greater than a default value by performing phase modulation on the carrier light, a digital signal processor to output the baseband OFDM signal, a reflective modulator to output the output light by modulating the carrier light in which the spectrum width is increased based on the baseband OFDM signal, and an optical circulator to change a path of the carrier light in which the spectrum width is increased to allow the carrier light in which the spectrum width is increased to be incident to the reflective modulator, and change a path of the output light output from the reflective modulator.

The phase modulator may output the carrier light in which the spectrum width is increased by increasing the spectrum width of the carrier light to be greater than the default value based on a tone.

The optical transmission apparatus may include an optical source to output the carrier light based on a wavelength or a frequency band pre-allocated to the optical transmission apparatus, a phase modulator to output the carrier light in which the spectrum width is increased to be greater than a default value by performing phase modulation on the carrier light, a digital signal processor to output the baseband OFDM signal, and an external modulator to output the output light by modulating the carrier light in which the spectrum width is increased based on the baseband OFDM signal.

The optical transmission apparatus may include a digital signal processor to output the baseband OFDM signal, an optical source to output the output light by generating the carrier light based on a wavelength or a frequency band pre-allocated to the optical transmission apparatus and modulating the carrier light based on the baseband OFDM signal, and an optical feedback unit to increase the spectrum width of the output light to be greater than the spectrum width of the carrier light by reflecting, to the optical source, a portion of the output light output from the optical source.

The optical transmission apparatus may include an optical source to output the carrier light based on a wavelength or a frequency band pre-allocated to the optical transmission apparatus, an optical feedback unit to increase the spectrum width of the carrier light to be greater than a default value by reflecting, to the optical source, a portion of the carrier light output from the optical source, a digital signal processor to output the baseband OFDM signal, and an external modulator to output the output light by modulating the carrier light in which the spectrum width is increased based on the baseband OFDM signal.

The optical transmission apparatus may include an optical source to output the carrier light based on a wavelength or a frequency band pre-allocated to the optical transmission apparatus, an optical feedback unit to increase the spectrum width of the carrier light to be greater than a default value by reflecting, to the optical source, a portion of the carrier light, a digital signal processor to output the baseband OFDM signal, a reflective modulator configured to output the output light by modulating the carrier light in which the spectrum width is increased based on the baseband OFDM signal, and an optical circulator to change a path of the carrier light in which the spectrum width is increased to allow the carrier light in which the spectrum width is increased to be incident to the reflective modulator, and change a path of the output light output from the reflective modulator to output the output light.

The optical transmission apparatus may include a photodiode to receive the output light from the optical transmission apparatus, a filter to filter a dithering tone from the output light, and a demodulator to demodulate the baseband OFDM signal from the output light from which the dithering tone is filtered.

According to another aspect of the present invention, there is provided an optical line terminal (OLT) including an optical source to output a carrier light in which a spectrum width is increased to be greater than a default value based on a wavelength or a frequency band pre-allocated to an optical transmission apparatus of an optical network unit (ONU), and an optical source generator to output the carrier light in which the spectrum width is increased to the optical transmission apparatus of the ONU.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of uplink transmission in an orthogonal frequency division multiple access-passive optical network (OFDMA-PON) according to an embodiment of the present invention;

FIG. 2 is a diagram illustrating an example of an output light according to an embodiment of the present invention;

FIG. 3 is a diagram illustrating an example of an electrical spectrum received by an optical reception apparatus according to an embodiment of the present invention;

FIG. 4 is a diagram illustrating a first example of a configuration of an optical transmission apparatus according to an embodiment of the present invention;

FIG. 5 is a diagram illustrating an example of a configuration of an optical reception apparatus according to an embodiment of the present invention;

FIG. 6 is a diagram illustrating a second example of a configuration of an optical transmission apparatus according to an embodiment of the present invention;

FIG. 7 is a diagram illustrating a third example of a configuration of an optical transmission apparatus according to an embodiment of the present invention;

FIG. 8 is a diagram illustrating a fourth example of a configuration of an optical transmission apparatus according to an embodiment of the present invention;

FIG. 9 is a diagram illustrating a fifth example of a configuration of an optical transmission apparatus according to an embodiment of the present invention;

FIG. 10 is a diagram illustrating a sixth example of a configuration of an optical transmission apparatus according to an embodiment of the present invention;

FIG. 11 is a diagram illustrating a seventh example of a configuration of an optical transmission apparatus according to an embodiment of the present invention;

FIG. 12 is a diagram illustrating an eighth example of a configuration of an optical transmission apparatus according to an embodiment of the present invention; and

FIG. 13 is a diagram illustrating an example of a configuration of an optical line terminal (OLT) according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

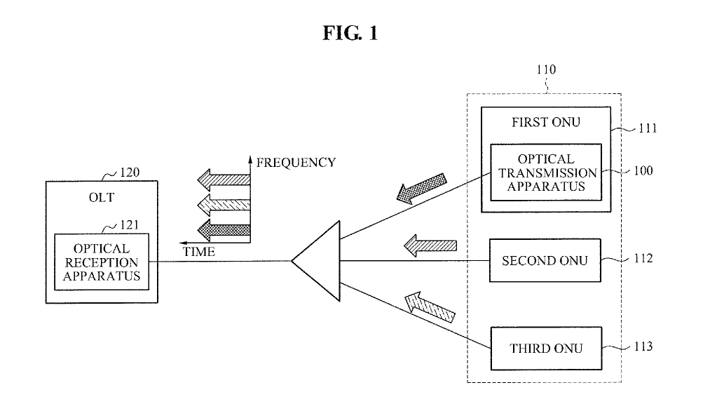

FIG. 1 is a diagram illustrating a structure of uplink transmission in an orthogonal frequency division multiple access-passive optical network (OFDMA-PON) according to an embodiment of the present invention.

Referring to FIG. 1, an OFDMA-PON system includes a plurality of optical network units (ONUs) 110 and an optical line terminal (OLT) 120.

Each of the plurality of ONUs 110 communicates with the OLT 120 by receiving subcarriers allocated for the uplink transmission and using the subcarriers. In detail, the subcarriers with different frequency bands may be allocated to a first ONU 111, a second ONU 112, and a third ONU 113. The first ONU 111, the second ONU 112, and the third ONU 113 may transmit, to the OLT 120, an output light loaded with a baseband orthogonal frequency division multiplexing (OFDM) signal present in a frequency band allocated to a carrier light. Here, each of the first ONU 111, the second ONU 112, and the third ONU 113 may include an optical transmission apparatus 100 including an optical source to output the carrier light. An operating wavelength band of the optical source included in the optical transmission apparatus 100 may be predetermined.

The optical transmission apparatus 100 may transmit the output light to the OLT 120 using an intensity modulation and direct detection method. The first ONU 111, the second ONU 112, and the third ONU 113 may use wavelengths slightly changed from respective normal wavelengths based on an operating condition. Thus, an optical beat interference (OBI) noise component corresponding to a difference in the normal wavelengths or frequencies between optical sources included in the optical transmission apparatus 100 of the first ONU 111, the second ONU 112, and the third ONU 113 may occur in a baseband OFDM signal bandwidth of the output light and accordingly, a quality in transmission of the output light received by the OLT 120 may deteriorate.

For example, when a photodiode of the OLT 120 receives output lights “S₁(t)” and “S₂(t)” having an identical polarized light, an electric field in the photodiode may be expressed by Equation 1.

E(t)=\sqrt{P₁(t)}E₁(t)+\sqrt{P₂(t)}E₂(t),Pᵢ(t)=Pᵢₙᵢ{1+mᵢaᵢ cos(2πfᵢt+φᵢ)} [Equation 1]

In Equation 1, “E₁(t)” denotes a normalized electric field of an optical source included in each of two ONUs to which the output lights S₁(t) and S₂(t) are transmitted. Also, current “i(t)” to be generated by the photodiode receiving the output lights S₁(t) and S₂(t) may be expressed by Equation 2.

i(t)=R{P₁(t)+P₂(t)+2\sqrt{P₁(t)P₂(t)}×cos(2πενt+φ₂(t)−φ₁(t))} [Equation 2]

In Equation 2, “δν” denotes a difference in center frequencies of optical sources included in the two ONUs, and “φᵢ(t)” denotes a phase of a carrier light to be output by each of the optical sources included in the two ONUs.

“P₁(t)” and “P₂(t)” denote baseband OFDM signals modulated in each of the two ONUs. Also, a final component of Equation 2 is an OBI noise component occurring by a mixing process of the photodiode.

When an OBI noise frequency spectrum of Equation 2 is known, a degree of a decline in a signal-to-noise ratio (SNR) by OBI noise may be obtained. The OBI noise frequency spectrum may be obtained based on a convolution of a frequency spectrum of an optical source included in each of the two ONUs.

For example, when the optical source included in each of the two ONUs is a single longitudinal mode (SLM) semiconductor laser, the SLM optical source may have a Lorentzian lineshape as expressed in Equation 3.

$$g ( v ) = \frac{Δ {v}_{FWHM}}{2 π [ {( v - {v}_{0} )}^{2} + {( \frac{Δ {v}_{FWHM}}{2} )}^{2} ]} \qquad [ Equation 3 ]$$

In Equation 3, “v₀” denotes a center frequency of the optical source, and “Δν_{FWHM}” denotes a full width at half maximum (FWHM). Also, “g(v),” which is a value of the Lorentzian lineshape, is normalized to be ∫_{-∞}^{+∞}g(ν)dv=1. Here, an OBI noise spectrum of the optical source included in each of the two ONUs may be induced based on Equation 4.

$${g}_{int} ( f ) = \frac{Δ {v}_{FWHM}}{π [ {( f - Δ v )}^{2} + Δ {v}_{FWHM}^{2} ]} \qquad [ Formula 4 ]$$

Equation 4 may be a normalized power spectrum of a third component represented in Equation 2. In Equation 4, the OBI noise spectrum component may be 2×ν_{FWHM}, in which a center frequency is present at Δν and a FWHM corresponds to a double of an existing optical source. For example, when the center frequencies of the optical sources included in the ONUs are almost matched, fᵢ>>Δν_{FWHM} may be obtained. Here, “fᵢ” denotes a normalized power spectrum of a third component of the current i(t), which may be an important factor to decrease an SNR because the OBI noise spectrum is present adjacent to a baseband. Here, “SNR_{OBI},” a value of the SNR that may decrease depending on the OBI noise, may be calculated based on Equation 5.

$${SNR}_{OBI} ( M = 2 , Δ v ) = \frac{π}{8} {m}^{2} \frac{Δ {v}_{FWHM}}{B} [ 1 + {( \frac{δ v}{Δ {v}_{FWHM}} )}^{2} \qquad [ Equation 5 ]$$

When the difference in the center frequencies or wavelengths of the optical sources included in the two ONUs is small, a center of the OBI noise spectrum may be present in a side of a direct current (DC) component and within a signal bandwidth and thus, the SNR_{OBI} may decrease. Conversely, when the difference in the center frequencies or wavelengths of the optical sources included in the two ONUs increases, the center of the OBI noise spectrum may be farther from the DC and left to be small within the signal bandwidth and thus, the SNR_{OBI} may increase.

For example, when the optical sources included in the two ONUs have a Gaussian lineshape, a steeper drop in the OBI noise spectrum may occur from an edge of the OBI noise spectrum in comparison to the Lorentzian lineshape. Thus, when the difference in the center frequencies of the optical sources included in the two ONUs increases, the OBI noise within the signal bandwidth may decrease. In detail, when the optical sources included in the two ONUs have the Gaussian lineshape and the difference in the center frequencies of the optical sources increases, the SNR_{OBI} may more rapidly increase in comparison to the case in which the optical sources have the Lorentzian lineshape, for example, an SLM laser.

In addition, an optical source such as a light emitting diode (LED) may have a broader spectrum line width, for example, “Δν_{FWHM}=50 nm,” in comparison to the SLM laser. Thus, although the OBI noise spectrum is present in a broader band irrespective of the center frequencies of the optical sources the LED may be less affected by the components in comparison to the SLM laser due to relatively small OBI noise spectrum components. Concisely, the greater the spectrum line width, the lower a degree of a decline in the SNR caused by the OBI noise.

Thus, the optical transmission apparatus 100 may reduce the degree of the decline in the SNR caused by the OBI noise by increasing a spectrum width of the output light in which the baseband OFDM signal is loaded onto the carrier light output from the optical source.

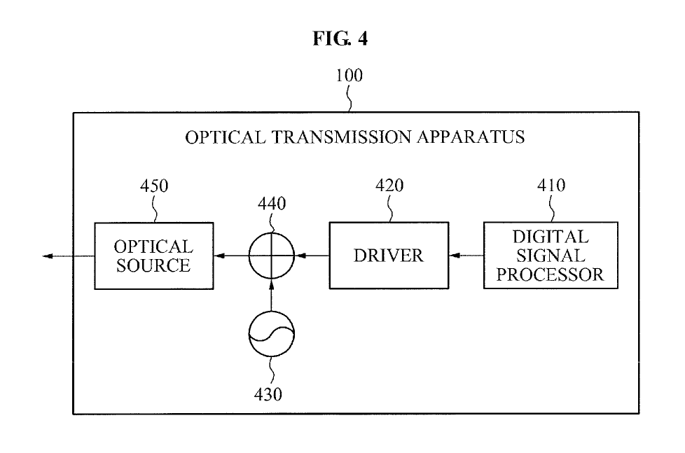

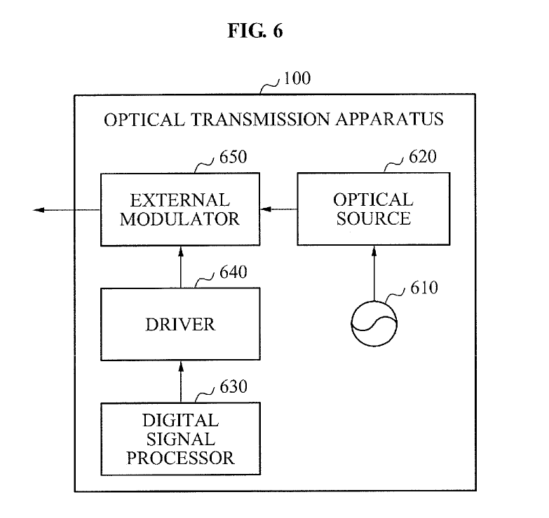

A detailed configuration and operation of the optical transmission apparatus 100 will be further described with reference to FIGS. 4 and 6.

The OLT 120 may communicate with the ONUs 110 by receiving uplink output lights transmitted from the ONUs 110. The OLT 120 may include an optical reception apparatus 121 to receive the output lights. The optical reception apparatus 121 may receive the baseband OFDM signal by demodulating the output light in which the spectrum width is increased by the optical transmission apparatus 100.

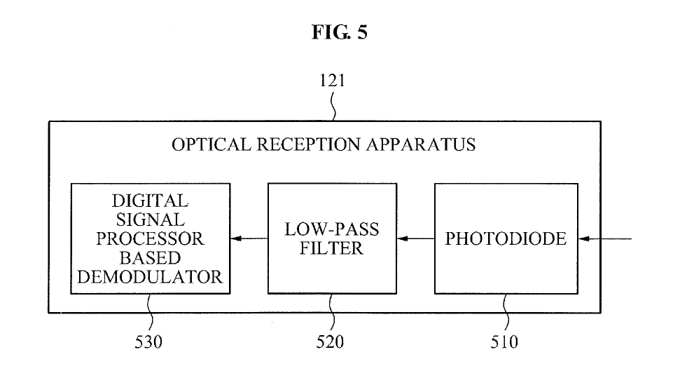

A detailed configuration of the optical reception apparatus 121 will be further described with reference to FIG. 5.

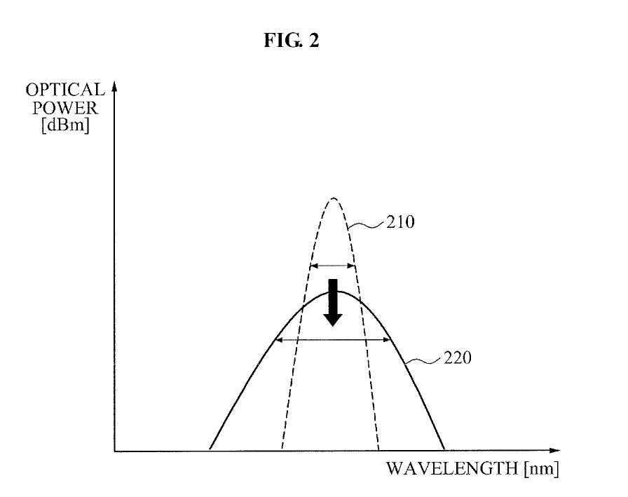

FIG. 2 is a diagram illustrating an example of an output light according to an embodiment of the present invention.

The optical transmission apparatus 100 may generate the output light based on a carrier light and a baseband OFDM signal. As illustrated in FIG. 2, a spectrum width 210 of the carrier light output from an optical source may be relatively narrow. The optical transmission apparatus 100 may combine various additional methods to increase a spectrum width 220 of the output light to be greater than the spectrum width 210 of the carrier light. Here, an OBI noise component occurring when the output light is received may be widely dispersed within an effective frequency band of a spectrum of the output light having the spectrum width 220 broader than the spectrum width 210 of the carrier light. Thus, an SNR may increase.

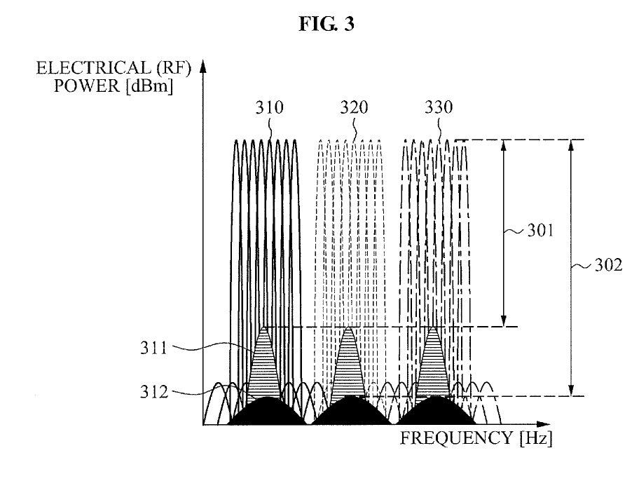

FIG. 3 is a diagram illustrating an example of an electrical spectrum received by the optical reception apparatus 121 according to an embodiment of the present invention.

Referring to FIG. 3, a first baseband OFDM subcarrier group, a second baseband OFDM subcarrier group, and a third baseband OFDM subcarrier group, which have different frequency bands from one another, may be allocated to the first ONU 111, the second ONU 112, and the third ONU 113, respectively.

The optical reception apparatus 121 of the OLT 120 may receive, from the first ONU 111, the second ONU 112, and the third ONU 113, a first output light, a second output light, and a third output light loaded with a first baseband OFDM subcarrier group signal 310, a second baseband OFDM subcarrier group signal 320, and a third baseband OFDM subcarrier group signal 330.

For example, when the first ONU 111 uses a conventional optical transmission apparatus including an optical source having a narrow line width, an OBI noise component 311 having a magnitude may be present in the first baseband OFDM subcarrier group signal 310 output from the optical transmission apparatus. Thus, an SNR 301 of an uplink optical signal to be received by the optical reception apparatus 121 of the OLT 120 may be determined based on a difference between a peak level of the first baseband OFDM group signal 310 and the OBI noise component 311.

However, when the first ONU 111 uses the optical transmission apparatus 100, an OBI noise component 312 having a magnitude may be present in the first baseband OFDM subcarrier group signal 310 output from the optical transmission apparatus 100. Thus, an SNR 302 of the uplink optical signal to be received by the optical reception apparatus 121 of the OLT 120 may be determined based on a difference between the peak level of the first baseband OFDM group signal 310 and the OBI noise component 312.

Here, the magnitude of the OBI noise component 312 may be reduced from the magnitude of the OBI noise component 311. Thus, the SNR 302 to be determined based on the difference between the peak level of the first baseband OFDM signal 310 and the OBI noise component 312 may be greater than the SNR 301 to be determined based on the difference between peak level of the first baseband OFDM signal 310 and the OBI noise component 311.

Concisely, the SNR 302 based on the first output light output from the optical transmission apparatus 100 may be increased in comparison to the SNR 301 based on the first output light output from the conventional optical transmission apparatus. Thus, transmission quality may be improved.

Similarly, the second ONU 112 and the third ONU 113 may also output the second output light and the third output light, respectively, using the optical transmission apparatus 100. Thus, SNRs based on the second output light and the third output light may be increased.

FIG. 4 is a diagram illustrating a first example of a configuration of the optical transmission apparatus 100 according to an embodiment of the present invention.

FIG. 4 illustrates the configuration of the optical transmission apparatus 100 that includes an optical source 450 capable of direct modulation and increases a spectrum width of a carrier light using a dithering tone. Referring to FIG. 4, the optical transmission apparatus 100 includes a digital signal processor 410, a driver 420, a tone generator 430, a synthesizer 440, and the optical source 450.

The digital signal processor 410 generates and outputs a baseband OFDM signal based on a subcarrier allocated to the optical transmission apparatus 100. The subcarrier allocated to the optical transmission apparatus 100 may be a subcarrier allocated to the ONUs 110.

The driver 420 may be used to drive the optical source 450. The driver 420 may drive the optical source 450 by applying the baseband OFDM signal output from the digital signal processor 410 to the optical source 450 through the synthesizer 440.

The tone generator 430 generates the dithering tone having a preset frequency and power. The preset frequency of the dithering tone may be greater than an overall bandwidth of the baseband OFDM signal and smaller than a modulation bandwidth of the optical source 450.

The synthesizer 440 synthesizes the dithering tone generated by the tone generator 430 and the baseband OFDM signal output from the digital signal processor 410, and transmits the baseband OFDM signal synthesized with the dithering tone to the optical source 450. Here, the synthesizer 440 may simultaneously apply the dithering tone and the baseband OFDM signal to the optical source 450 by synthesizing the dithering tone and the baseband OFDM signal.

The optical source 450 outputs an output light in which a spectrum width is increased to be greater than the spectrum width of the carrier light based on the baseband OFDM signal synthesized with the dithering tone. Here, the optical source 450 outputs the output light by directly modulating a magnitude of the carrier light based on the baseband OFDM signal received from the driver 420. In addition, the optical source 450 increases the spectrum width of the carrier light based on the dithering tone received from the tone generator 430 through the synthesizer 440. For example, the optical source 450 may generate the carrier light in a wavelength or a frequency band pre-allocated to the optical transmission apparatus 100. The optical source 450 outputs the output light in which the spectrum width is increased to be greater than the spectrum width of the carrier light by modulating the generated carrier light based on the baseband OFDM signal synthesized with the dithering tone. The optical source 450 loads the baseband OFDM signal onto the carrier light by modulating the carrier light based on the baseband OFDM signal.

The optical source 450 may then diffuse an OBI noise component in the electrical frequency band by the increased spectrum width by outputting the output light in which the spectrum width is increased to be greater than the spectrum width of the carrier light. Thus, the OBI noise component diffused within the frequency band may increase an SNR and accordingly, deterioration in a quality of uplink transmission may be avoided.

In addition, the optical source 450 may not be required to possess a wavelength independence property. For example, the optical source 450 may have a normal wavelength and be any one of a distributed feedback-laser diode (DFB-LD), a distributed Bragg reflector (DBR) laser, an external cavity laser (ECL), and a vertical cavity surface-emitting laser (VCSEL).

FIG. 5 is a diagram illustrating an example of a configuration of the optical reception apparatus 121 according to an embodiment of the present invention.

Referring to FIG. 5, the optical reception apparatus 121 includes a photodiode 510, a low-pass filter 520, and a digital signal processor based demodulator 530.

The photodiode 510 receives, from the optical transmission apparatus 100 of the ONUs 110, an output light in which a spectrum width is increased to be greater than a spectrum width of a carrier light.

The low-pass filter 520 filters a dithering tone from a frequency domain after performing all-optical conversion on the output light received by the photodiode 510.

The digital signal processor based demodulator 530 demodulates a baseband OFDM signal from a received signal from which the dithering tone is filtered.

FIG. 6 is a diagram illustrating a second example of a configuration of the optical transmission apparatus 100 according to an embodiment of the present invention.

FIG. 6 illustrates an example of the optical transmission apparatus 100 that increases a spectrum width of a carrier light using a dithering tone and outputs an output light using an external modulator 650. Referring to FIG. 6, the optical transmission apparatus 100 includes a tone generator 610, an optical source 620, a digital signal processor 630, a driver 640, and the external modulator 650.

The tone generator 610 generates the dithering tone having a preset frequency and power. The dithering tone generated by the tone generator 610 may be identical to the dithering tone generated by the tone generator 430 of FIG. 4.

The optical source 620 generates the carrier light in a wavelength or a frequency band pre-allocated to the optical transmission apparatus 100. The optical source 620 increases the spectrum width of the carrier light using the dithering tone. The optical source 620 may be, for example, a laser diode possessing a continuous-wavelength (CW) property. In this case, the optical source 620 may output the carrier light in which the spectrum width is increased using the dithering tone applied by the tone generator 610. Here, the wavelength or the frequency band pre-allocated to the optical transmission apparatus 100 may be a wavelength or a frequency band pre-allocated to the ONUs 110 including the optical transmission apparatus 100.

The digital signal processor 630 generates a baseband OFDM signal based on a subcarrier allocated to the optical transmission apparatus 100. The digital signal processor 630 may be, for example, a digital signal processor based modulator.

The driver 640 may be used to drive the external modulator 650. The driver 640 may drive the external modulator 650 by applying the baseband OFDM signal output from the digital signal processor 630 to the external modulator 650.

The external modulator 650 generates an output signal by externally modulating the carrier light output from the optical source 620 and in which the spectrum width is increased based on the baseband OFDM signal output from the digital signal processor 630. Here, the external modulator 650 may load the OFDM signal onto the carrier light in which the spectrum width is increased by externally modulating the carrier light in which the spectrum width is increased based on the baseband OFDM signal. The external modulator 650 may be, for example, a Mach-Zehnder modulator (MZM) or an electro-absorption modulator (EAM).

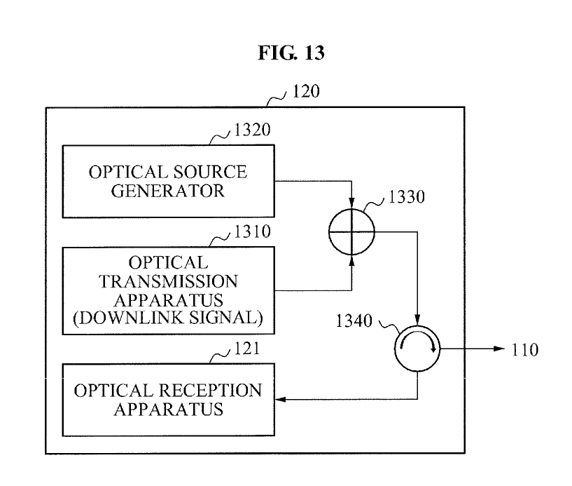

As illustrated in FIG. 6, the tone generator 610 and the optical source 620 that may be used to output the carrier light in which the spectrum width is increased may be included in the optical transmission apparatus 100 of the ONUs 110. Also, the tone generator 610 and the optical source 620 may be included in the OLT 120, and the OLT 120 may distribute, to each of the ONUs 110, the carrier light output from the optical source 620 and in which the spectrum width is increased. Thus, the central OLT 120 may intensively control the carrier light in which the spectrum width is increased. An example in which components such as the tone generator 610 and the optical source 620 used to output the carrier light in which the spectrum width is increased are included in the OLT 120 will be further described with reference to FIG. 13.

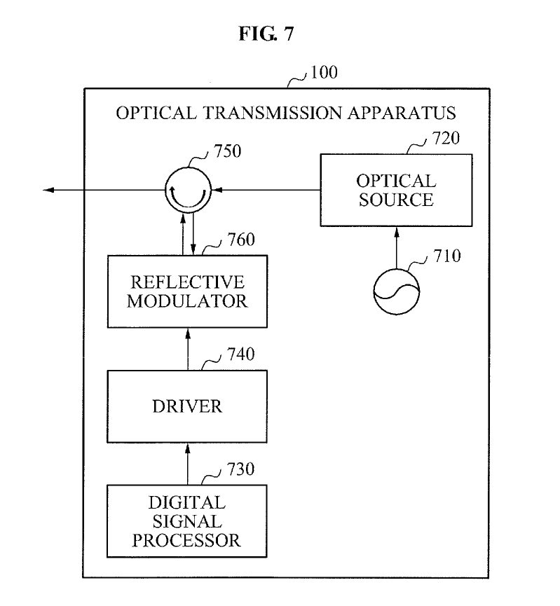

FIG. 7 is a diagram illustrating a third example of a configuration of the optical transmission apparatus 100 according to an embodiment of the present invention.

FIG. 7 illustrates an example of the optical transmission apparatus 100 that increases a spectrum width of a carrier light using a dithering tone and outputs an output light using a reflective modulator 760. Referring to FIG. 7, the optical transmission apparatus 100 includes a tone generator 710, an optical source 720, a digital signal processor 730, a driver 740, an optical circulator 750, and the reflective modulator 760.

The tone generator 710 generates the dithering tone having a preset frequency and power. The dithering tone generated by the tone generator 710 may be identical to the dithering tone generated by the tone generator 430 of FIG. 4.

The optical source 720 generates the carrier light in a wavelength or a frequency band pre-allocated to the optical transmission apparatus 100. The optical source 720 outputs the carrier light in which the spectrum width is increased to be greater than a default value by increasing the carrier light using the dithering tone. The digital signal processor 730 outputs a baseband OFDM signal based on a subcarrier allocated to the optical transmission apparatus 100. The digital signal processor 730 may be, for example, a digital signal processor based modulator.

The driver 740 may be used to drive the reflective modulator 760. The driver 740 may drive the reflective modulator 760 by applying the baseband OFDM signal output from the digital signal processor 730 to the reflective modulator 760.

The optical circulator 750 changes a path of the carrier light output from the optical source 720 and in which the spectrum width is increased to allow the carrier light to be incident to the reflective modulator 760, and changes a path of an output light output from the reflective modulator 760 to transmit the output light to the OLT 120.

Here, the reflective modulator 760 may load the baseband OFDM signal output from the digital signal processor 730 onto the carrier light output from the optical source 720 and in which the spectrum width is increased. The reflective modulator 760 may be, for example, a reflective semiconductor optical amplifier (RSOA), a wavelength locked Fabry-Perot laser diode (FP-LD), or a reflective electro-absorption modulator (REAM).

The reflective modulator 760 loads the baseband OFDM signal onto the carrier light in which the spectrum width is increased by modulating the carrier light in which the spectrum width is increased based on the baseband OFDM signal. That is, the carrier light in which the spectrum width is increased and allowed to be incident to the reflective modulator 760 by the optical circulator 750 may be modulated based on the baseband OFDM signal. The reflective modulator 760 may output the carrier light loaded with the baseband OFDM signal to the optical circulator 750. The optical circulator 750 may then transmit the output light to the OLT 120 by changing the path of the output light output from the reflective modulator 760 to an optical line connected to the OLT 120.

As illustrated in FIG. 7, the tone generator 710 and the optical source 720 used to output the carrier light in which the spectrum width is increased may be included in the optical transmission apparatus 100 of the ONUs 110. Also, the tone generator 710 and the optical source 720 may be included in the OLT 120, and the OLT 120 may distribute, to each of the ONUs 110, the carrier light output from the optical source 720 and in which the spectrum width is increased. Thus, the central OLT 120 may intensively control the carrier light in which the spectrum width is increased. An example of components such as the tone generator 710 and the optical source 720 used to output the carrier light in which the spectrum width is increased being included in the OLT 120 will be further described with reference to FIG. 13.

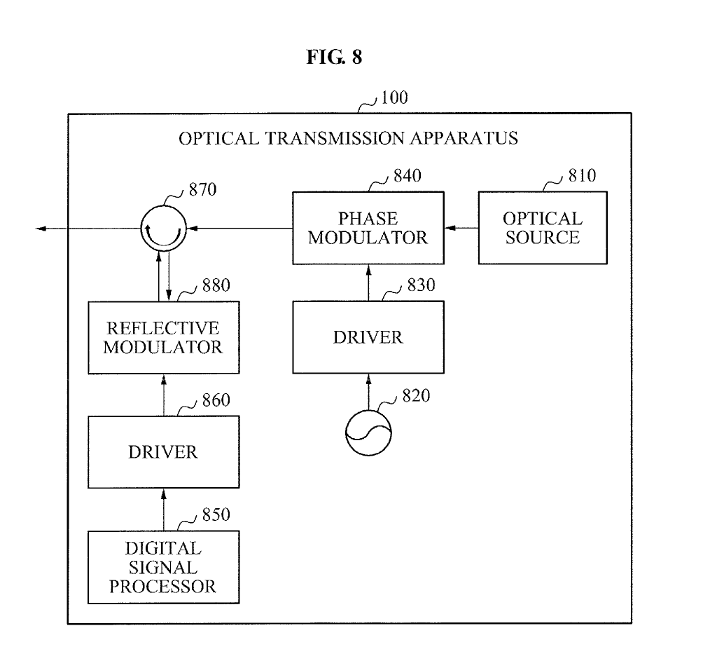

FIG. 8 is a diagram illustrating a fourth example of a configuration of the optical transmission apparatus 100 according to an embodiment of the present invention.

FIG. 8 illustrates an example of the optical transmission apparatus 100 that increases a spectrum width of a carrier light using a phase modulator 840, modulates the carrier light in which the spectrum width is increased using a reflective modulator 880, and outputs the modulated carrier light. Referring to FIG. 8, the optical transmission apparatus 100 includes an optical source 810, a tone generator 820, a driver 830, the phase modulator 840, a digital signal processor 850, a driver 860, an optical circulator 870, and the reflective modulator 880.

The optical source 810 generates the carrier light in a wavelength or a frequency band pre-allocated to the optical transmission apparatus 100.

The tone generator 820 generates a tone and outputs the generated tone to the driver 830.

The driver 830 may be used to drive the phase modulator 840. The driver 830 may drive the phase modulator 840 by applying the tone output from the tone generator 820 to the phase modulator 840.

The phase modulator 840 increases the spectrum width of the carrier light by performing phase modulation on the carrier light output from the optical source 810. The phase modulator 840 increases the spectrum width of the carrier light in proportion to an electrical frequency of the tone generated by the tone generator 820. The phase modulator 840 outputs the carrier light in which the spectrum width is increased to be greater than a default value. In addition, the phase modulator 840 may improve properties of the carrier light by combining a polarization splitter/coupler, an optical amplifier, and polarization controllers to increase an output efficiency of the carrier light in which the spectrum width is increased. The phase modulator 840 may be, for example, a phase modulator in a form of a lithium niobate Mach-Zehnder modulator (LN-MZM).

The digital signal processor 850 outputs a baseband OFDM signal based on a subcarrier allocated to the optical transmission apparatus 100. The digital signal processor 850 may be, for example, a digital signal processor based modulator.

The driver 860 may be used to drive the reflective modulator 880. The driver 860 may drive the reflective modulator 880 by applying the baseband OFDM signal output from the digital signal processor 850 to the reflective modulator 880.

The optical circulator 870 changes a path of the carrier light output from the optical source 820 and in which the spectrum width is increased to allow the carrier light to be incident to the reflective modulator 880, and changes a path of an output light output from the reflective modulator 880 to output the output light to the OLT 120.

The reflective modulator 880 outputs the output light by modulating the carrier light output from the optical source 820 and in which the spectrum width is increased based on the baseband OFDM signal output from the digital signal processor 850. Here, the reflective modulator 880 may load the baseband OFDM signal onto the carrier light in which the spectrum width is increased by modulating the carrier light in which the spectrum light is increased based on the baseband OFDM signal. That is, the carrier light incident to the reflective modulator 880 by the optical circulator 870 may be modulated based on the OFDM signal. The reflective modulator 880 outputs, to the optical circulator 870, the output light, which is the carrier light in which the spectrum width is increased and loaded with the baseband OFDM signal. The optical circulator 870 transmits the output light to the OLT 120 by changing the path of the output light output from the reflective modulator 880 to an optical line connected to the OLT 120.

As illustrated in FIG. 8, the optical source 810, the tone generator 820, the driver 830, and the phase modulator 840 used to output the carrier light in which the spectrum width is increased may be included in the optical transmission apparatus 100 of the ONUs 110. Also, the optical source 810, the tone generator 820, the driver 830, and the phase modulator 840 may be included in the OLT 120, and the OLT 120 may distribute, to each of the ONUs 110, the carrier light output from the phase modulator 840 and in which the spectrum width is increased. Thus, the central OLT 120 may intensively control the carrier light in which the spectrum width is increased. An example in which components such as the optical source 810, the tone generator 820, the driver 830, and the phase modulator 840 used to output the carrier light in which the spectrum width is increased are included in the OLT 120 will be further described with reference to FIG. 13.

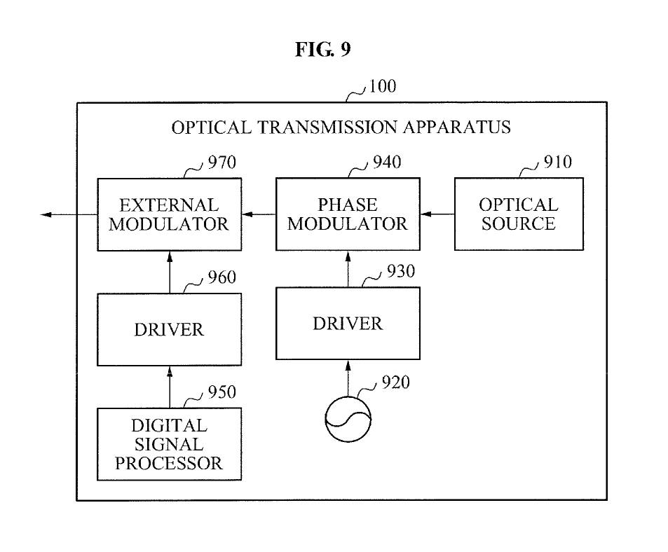

FIG. 9 is a diagram illustrating a fifth example of a configuration of the optical transmission apparatus 100 according to an embodiment of the present invention.

FIG. 9 illustrates an example of the optical transmission apparatus 100 that increases a spectrum width of a carrier light using a phase modulator 940, and outputs an output light using an external modulator 970. Referring to FIG. 9, the optical transmission apparatus 100 includes an optical source 910, a tone generator 920, a driver 930, the phase modulator 940, a digital signal processor 950, a driver 960, and the external modulator 970.

The optical source 910 generates the carrier light in a wavelength or a frequency band pre-allocated to the optical transmission apparatus 100.

The tone generator 920 generates a tone and outputs the generated tone to the driver 930.

The driver 930 may be used to drive the phase modulator 940. The driver 930 may drive the phase modulator 940 by applying the tone output from the tone generator 920 to the phase modulator 940.

The phase modulator 940 increases the spectrum width of the carrier light by performing phase modulation on the carrier light output from the optical source 910. The phase modulator 940 increases the spectrum width of the carrier light in proportion to an electrical frequency of the tone generated by the tone generator 920. The phase modulator 940 outputs the carrier light in which the spectrum width is increased to be greater than a default value. In addition, the phase modulator 940 may improve properties of the carrier light by at least one of a polarization splitter/coupler, an optical amplifier, and a polarization controller to increase an output efficiency of the carrier light in which the spectrum width is increased.

The digital signal processor 950 outputs a baseband OFDM signal based on a subcarrier allocated to the optical transmission apparatus 100. The digital signal processor 950 may be, for example, a digital signal processor based modulator.

The driver 960 may be used to drive the external modulator 970. The driver 960 may apply the baseband OFDM signal output from the digital signal processor 950 to the external modulator 970.

The external modulator 970 outputs an output light by modulating the carrier light output from the phase modulator 940 and in which the spectrum width is increased based on the baseband OFDM signal output from the digital signal processor 950. Here, the external modulator 970 may load the baseband OFDM signal onto the carrier light in which the spectrum width is increased by modulating the carrier light in which the spectrum width is increased based on the OFDM signal.

As illustrated in FIG. 9, the optical source 910, the tone generator 920, the driver 930, and the phase modulator 940 used to output the carrier light in which the spectrum width is increased may be included in the optical transmission apparatus 100 of the ONUs 110. Also, the optical source 910, the tone generator 920, the driver 930, and the phase modulator 940 may be included in the OLT 120, and the OLT 120 may distribute, to each of the ONUs 110, the carrier light output from the phase modulator 940 and in which the spectrum width is increased. Thus, the central OLT 120 may intensively control the carrier light in which the spectrum width is increased. An example in which components such as the optical source 910, the tone generator 920, the driver 930, and the phase modulator 940 used to output the carrier light in which the spectrum width is increased are included in the OLT 120 will be further described with reference to FIG. 13.

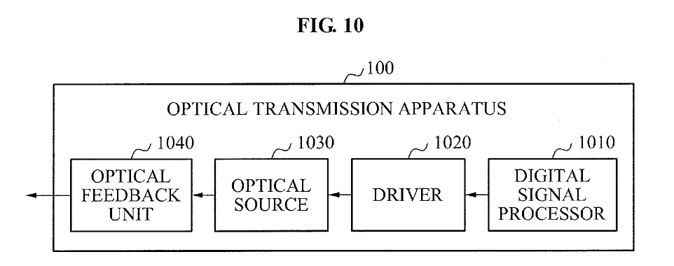

FIG. 10 is a diagram illustrating a sixth example of a configuration of the optical transmission apparatus 100 according to an embodiment of the present invention.

FIG. 10 illustrates an example of the optical transmission apparatus 100 that increases a spectrum width of an output light using an optical feedback unit 1040. For example, when a proportional output, among output lights having a coherent property, is fed back to an optical source that outputs the output light, coherence may be collapsed and a spectrum of the output light may become broader. Thus, feeding the output light output from the optical source back to the optical source may increase the spectrum width of the output light without using a complex and high-priced optical component or a radio frequency (RF) component. Referring to FIG. 10, the optical transmission apparatus 100 includes a digital signal processor 1010, a driver 1020, an optical source 1030, and the optical feedback unit 1040.

The digital signal processor 1010 outputs a baseband OFDM signal based on a subcarrier allocated to the optical transmission apparatus 100.

The driver 1020 may be used to drive the optical source 1030. The driver 1020 may drive the optical source 1030 by applying the baseband OFDM signal output from the digital signal processor 1010 to the optical source 1030.

The optical source 1030 generates a carrier light based on a wavelength or a frequency band pre-allocated to the optical transmission apparatus 100, and generates the output light by loading the baseband OFDM signal applied from the driver 1020 onto the carrier light. For example, the optical source 1030 may be able to perform direct modulation and have a normal wavelength. The carrier light generated by the optical source 1030 may have the coherent property.

The optical feedback unit 1040 reflects, to the optical source 1030, a portion of the output light output from the optical source 1030 to increase the spectrum width of the output light to be greater than the spectrum width of the carrier light. The optical feedback unit 1040 may be a partial mirror, or include a polarization adjustor, an optical power distributor, and an optical attenuator.

The output light fed back to the optical source 1030 may degrade a relative intensity noise (RIN) property and a modulation bandwidth performance of the optical source 1030 capable of the direct modulation. Thus, the optical source 1030 may prevent the degradation of the RIN property and the modulation bandwidth performance of the optical source 1030 by performing zero padding on a low-frequency band OFDM subcarrier positioned adjacent to direct current (DC) and a high-frequency band OFDM subcarrier.

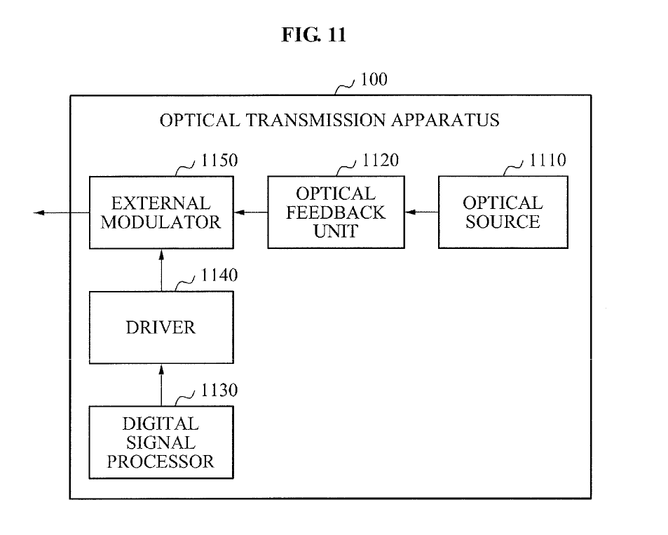

FIG. 11 is a diagram illustrating a seventh example of a configuration of the optical transmission apparatus 100 according to an embodiment of the present invention.

FIG. 11 illustrates an example of the optical transmission apparatus 100 that increases a spectrum width of a carrier light using an optical feedback unit 1120, and outputs an output light using an external modulator 1150. Dissimilar to the sixth example illustrated in FIG. 10, the optical transmission apparatus 100 illustrated in FIG. 11 may not use an optical source capable of direct modulation. Thus, deterioration in an RIN property and modulation bandwidth performance that may be caused by an output light fed back to the optical source capable of the direct modulation may be avoided. Accordingly, a desirable transmission bandwidth and transmission quality may be acquired because an additional process of controlling and adjusting a baseband OFDM subcarrier is unnecessary. Referring to FIG. 11, the optical transmission apparatus 100 includes an optical source 1110, the optical feedback unit 1120, a digital signal processor 1130, a driver 1140, and the external modulator 1150.

The optical source 1110 outputs a carrier light in a wavelength or a frequency band pre-allocated to the optical transmission apparatus 100.

The optical feedback unit 1120 increases a spectrum width of the carrier light to be greater than a default value by reflecting, to the optical source 1110, a portion of the carrier light output from the optical source 1110.

The digital signal processor 1130 outputs a baseband OFDM signal based on a subcarrier allocated to the optical transmission apparatus 100.

The driver 1140 may be used to drive the external modulator 1150. The driver 1140 may drive the external modulator 1150 by applying the baseband OFDM signal output from the digital signal processor 1130 to the external modulator 1150.

The external modulator 1150 outputs the output light by modulating the carrier light in which the spectrum width is increased by the optical feedback unit 1120 based on the baseband OFDM signal output from the digital signal processor 1130. Here, the external modulator 1150 may load the baseband OFDM signal onto the carrier light in which the spectrum width is increased by modulating the carrier light in which the spectrum width is increased based on the baseband OFDM signal.

As illustrated in FIG. 11, the optical source 1110 and the optical feedback unit 1120 used to output the carrier light in which the spectrum width is increased may be included in the optical transmission apparatus 100 of the plurality of ONUs 110 of FIG. 1. Also, the optical source 1110 and the optical feedback unit 1120 may be included in the OLT 120, and the OLT 120 may distribute, to each of the ONUs 110, the carrier light in which the spectrum width is increased. Thus, the central OLT 120 may intensively control the carrier light in which the spectrum width is increased. An example in which components such as the optical source 1110 and the optical feedback unit 1120 used to output the carrier light in which the spectrum width is increased are included in the OLT 120 will be further described with reference to FIG. 13.

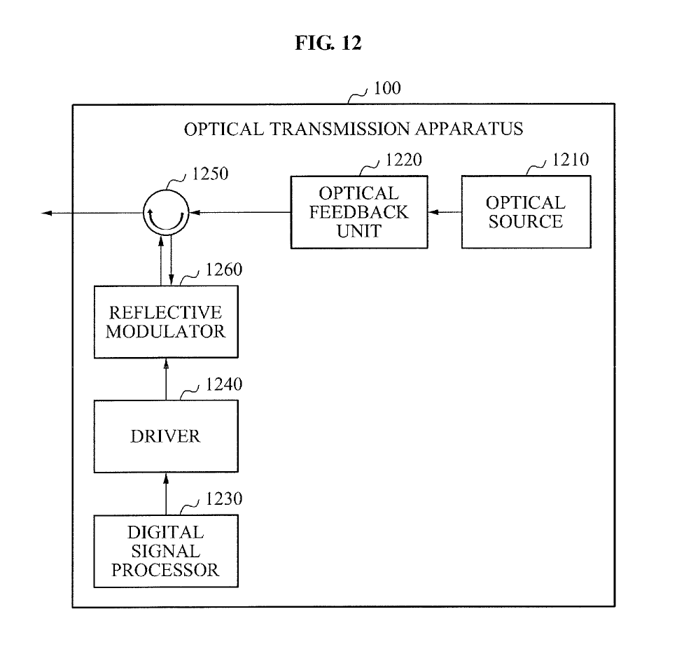

FIG. 12 is a diagram illustrating an eighth example of a configuration of the optical transmission apparatus 100 according to an embodiment of the present invention.

FIG. 12 illustrates an example of the optical transmission apparatus 100 that increases a spectrum width of a carrier light using an optical feedback unit 1220 and outputs an output light using a reflective modulator 1260. Referring to FIG. 12, the optical transmission apparatus 100 includes an optical source 1210, the optical feedback unit 1220, a digital signal processor 1230, a driver 1240, an optical circulator 1250, and the reflective modulator 1260.

The optical source 1210 outputs the carrier light in a wavelength or a frequency band pre-allocated to the optical transmission apparatus 100.

The optical feedback unit 1220 increases the spectrum width of the carrier light to be greater than a default value by reflecting, to the optical source 1210, a portion of the carrier light output from the optical source 1210.

The digital signal processor 1230 outputs a baseband OFDM signal based on a subcarrier allocated to the optical transmission apparatus 100.

The driver 1240 may be used to drive the reflective modulator 1260. The driver 1240 may drive the reflective modulator 1260 by applying the baseband OFDM signal output from the digital signal processor 1230 to the reflective modulator 1260.

The optical circulator 1250 changes a path of the carrier light in which the spectrum width is increased by the optical feedback unit 1220 to allow the carrier light to be incident to the reflective modulator 1260, and changes a path of the output light output from the reflective modulator 1260 to output the output light to the OLT 120.

The reflective modulator 1260 outputs the output light by modulating the carrier light in which the spectrum width is increased by the optical feedback unit 1220 based on the baseband OFDM signal output from the digital signal processor 1230. Here, the reflective modulator 1260 may load the baseband OFDM signal onto the carrier light in which the spectrum width is increased by modulating the carrier light in which the spectrum light is increased based on the baseband OFDM signal. Concisely, the carrier light allowed to be incident to the reflective modulator 1260 by the optical circulator 1250 may be modulated based on the baseband OFDM signal. The reflective modulator 1260 outputs, to the optical circulator 1250, the output light, which is the carrier light loaded with the baseband OFDM signal. The optical circulator 1250 transmits the output light to the OLT 120 by changing the path of the output light output from the reflective modulator 1260 to an optical line connected to the OLT 120.

As illustrated in FIG. 12, the optical source 1210 and the optical feedback unit 1220 used to output the carrier light in which the spectrum width is increased may be included in the optical transmission apparatus 100 of the ONUs 110. Also, the optical source 1210 and the optical feedback unit 1220 may be included in the OLT 120, and the OLT 120 may distribute, to each of the ONUs 110, the carrier light in which the spectrum width is increased by the optical feedback unit 1220. Thus, the central OFT 120 may intensively control the carrier light in which the spectrum width is increased. An example in which components such as the optical source 1210 and the optical feedback unit 1220 used to output the carrier light in which the spectrum width is increased are included in the OLT 120 will be further described with reference to FIG. 13.

FIG. 13 is a diagram illustrating an example of a configuration of the OLT 120 according to an embodiment of the present invention.

FIG. 13 illustrates an example of the OLT 120 that generates a carrier light in which a spectrum width is increased, transmits the carrier light to the optical transmission apparatus 100 of the ONUs 110, and allows the optical transmission apparatus 100 of the ONUs 110 to modulate an output light. The optical transmission apparatus 100 of the ONUs 110 may modulate the received carrier light in which the spectrum width is increased using an external modulator to generate the output light, and transmit the generated output light to the optical reception apparatus 121 of the OLT 120.

Referring to FIG. 13, the OLT 120 includes the optical transmission apparatus 121, an optical transmission apparatus 1310, an optical source generator 1320, an optical coupler 1330, and an optical circulator 1340.

The optical reception apparatus 121 of FIG. 13 may have an identical configuration and perform identical operations to the optical reception apparatus 121 of FIG. 5. The optical transmission apparatus 1310 receives subcarriers allocated for downlink transmission, and communicates with the ONUs 110 using the allocated subcarriers. The optical transmission apparatus 1310 loads a downlink signal onto a carrier light in an allocated frequency band and transmits the carrier light loaded with the downlink signal.

The optical source generator 1320 generates a carrier light in which a spectrum width is increased for uplink transmission and outputs the generated carrier light in which the spectrum width is increased.

For example, the optical source generator 1320 may include the tone generator 610 and the optical source 620 of FIG. 6. The optical source 620 included in the optical source generator 1320 may generate carrier lights in a wavelength or a frequency band pre-allocated to each of the optical transmission apparatus 100. Also, spectrum widths of the carrier lights output from the optical source 620 may be increased by the tone generator 610 included in the optical source generator 1320. The optical source generator 1320 may then transmit the carrier lights in which the respective spectrum widths are increased to the optical transmission apparatus 100 of the ONUs 110. The optical source generator 1320 may determine, among the optical transmission apparatus 100 of the ONUs 110, an optical transmission apparatus to transmit the carrier light in which the spectrum width is increased based on a wavelength or a frequency band of the carrier in which the spectrum width is increased.

For another example, the optical source generator 1320 may include the optical source 910, the tone generator 920, the driver 930, and the phase modulator 940 of FIG. 9. The optical source 910 included in the optical source generator 1320 may generate carrier lights in a wavelength or a frequency band pre-allocated to each of the optical transmission apparatus 100. The driver 930 may drive the phase modulator 940 by applying a tone output from the tone generator 920 to the phase modulator 940. Subsequently, the phase modulator 940 may increase a spectrum width of a carrier light by performing phase modulation on the carrier light output from the optical source 910. The phase modulator 940 may increase the spectrum width of the carrier light in proportion to an electrical frequency of the tone generated by the tone generator 920. The optical source generator 1320 may then determine the optical transmission apparatus 100 of the ONUs 110 to transmit the carrier light in which spectrum width is increased based on a wavelength or a frequency band of the carrier light in which the spectrum width is increased.

For still another example, the optical source generator 1320 may include the optical source 1110 and the optical feedback unit 1120 of FIG. 11. The optical source 1110 included in the optical source generator 1320 may generate carrier lights in a wavelength or a frequency band pre-allocated to each of optical transmission apparatuses. The optical feedback unit 1120 may increase spectrum widths of the carrier lights to be greater than a default value by reflecting a portion of the carrier lights output from the optical source 1110. The optical source generator 1320 may transmit, to the optical transmission apparatus 100 of the ONUs 110, the carrier lights in which the spectrum widths are increased. The optical source generator 1320 may determine the optical transmission apparatus 100 to transmit the carrier light in which the spectrum width is increased based on a wavelength or a frequency band of the carrier light in which the spectrum width is increased.

The optical coupler 1330 combines the carrier light loaded with the downlink signal output from the optical transmission apparatus 1310 and the carrier light output from the optical source generator 1320 and in which the spectrum width is increased, and transmits the combined carrier light to the optical circulator 1340. Here, the optical coupler 1330 may simultaneously transmit, to the optical transmission apparatus 100 of the ONUs 110, the carrier light loaded with the downlink signal and the carrier light in which the spectrum width is increased by combing the two carrier lights.

The optical circulator 1340 transmits the carrier light combined by the optical coupler 1330 to the optical transmission apparatus 100 of the ONUs 110. When the optical circulator 1340 receives an uplink light from the optical transmission apparatus 100 of the ONUs 110, the optical circulator 1340 may transmit the received uplink light to the optical reception apparatus 121.

According to example embodiments of the present invention, deterioration in transmission performance that may be caused by OBI noise occurring in uplink transmission may be prevented or reduced by increasing a spectrum width of an output light in an orthogonal frequency division multiple access-passive optical network (OFDMA-PON) uplink using a plurality of independent ONU optical sources.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical transmission apparatus configured to output an output light by modulating a carrier light based on a baseband orthogonal frequency division multiplexing (OFDM) signal, and increase a spectrum width of the carrier light or a spectrum width of the output light.

2. The apparatus of claim 1, comprising:
a digital signal processor configured to output the baseband OFDM signal;
a tone generator configured to generate a dithering tone;
a synthesizer configured to synthesize the dithering tone and the baseband OFDM signal; and
an optical source configured to output the output light in which the spectrum width is increased to be greater than the spectrum width of the carrier light based on the baseband OFDM signal synthesized with the dithering tone.

3. The apparatus of claim 2, wherein a frequency of the dithering tone is greater than an overall bandwidth of the baseband OFDM signal and smaller than a modulation bandwidth of the optical source.

4. The apparatus of claim 2, wherein the optical source is configured to generate the output light by generating the carrier light based on a wavelength or a frequency band pre-allocated to the optical transmission apparatus, increasing the spectrum width of the carrier light using the dithering tone, and modulating the carrier light in which the spectrum width is increased based on the baseband OFDM signal.

5. The apparatus of claim 1, comprising:
an optical source configured to generate the carrier light based on a wavelength or a frequency band pre-allocated to the optical transmission apparatus, increase the spectrum width of the carrier light using a dithering tone, and output the carrier light in which the spectrum width is increased;
a digital signal processor configured to output the baseband OFDM signal; and
an external modulator configured to output the output light by modulating the carrier light in which the spectrum width is increased based on the baseband OFDM signal.

6. The apparatus of claim 1, comprising:
an optical source configured to generate the carrier light based on a wavelength or a frequency band pre-allocated to the optical transmission apparatus, increase the spectrum width of the carrier light using a dithering tone, and output the carrier light in which the spectrum width is increased;
a digital signal processor configured to output the baseband OFDM signal;
a reflective modulator configured to output the output light by modulating the carrier light in which the spectrum width is increased to be greater than a default value based on the baseband OFDMA signal; and
an optical circulator configured to change a path of the carrier light in which the spectrum width is increased to allow the carrier light in which the spectrum width is increased to be incident to the reflective modulator, and change a path of the output light to output the output light.

7. The apparatus of claim 1, comprising:
an optical source configured to output the carrier light based on a wavelength or a frequency band pre-allocated to the optical transmission apparatus;
a phase modulator configured to increase the spectrum width of the carrier light by performing phase modulation on the carrier light;
a digital signal processor configured to output the baseband OFDM signal;
a reflective modulator configured to output the output light by modulating the carrier light in which the spectrum width is increased based on the baseband OFDM signal; and
an optical circulator configured to change a path of the carrier light in which the spectrum width is increased to allow the carrier light in which the spectrum width is increased to be incident to the reflective modulator, and change a path of the output light output from the reflective modulator.

8. The apparatus of claim 7, wherein the phase modulator is configured to increase the spectrum width of the carrier light in proportion to an electrical frequency of a tone.

9. The apparatus of claim 1, comprising:
an optical source configured to output the carrier light based on a wavelength or a frequency band pre-allocated to the optical transmission apparatus;
a phase modulator configured to output a carrier light in which the spectrum width is increased to be greater than a default value by performing phase modulation on the carrier light;
a digital signal processor configured to output the baseband OFDM signal; and
an external modulator configured to output the output light by modulating the carrier light in which the spectrum width is increased based on the baseband OFDM signal.

10. The apparatus of claim 1, comprising:
a digital signal processor configured to output the baseband OFDM signal;
an optical source configured to output the output light by generating the carrier light based on a wavelength or a frequency band pre-allocated to the optical transmission apparatus and modulating the carrier light based on the baseband OFDM signal; and
an optical feedback unit configured to increase the spectrum width of the output light to be greater than the spectrum width of the carrier light by reflecting, to the optical source, a portion of the output light output from the optical source.

11. The apparatus of claim 1, comprising:
an optical source configured to output the carrier light based on a wavelength or a frequency band pre-allocated to the optical transmission apparatus;
an optical feedback unit configured to increase the spectrum width of the carrier light to be greater than a default value by reflecting, to the optical source, a portion of the carrier light output from the optical source;
a digital signal processor configured to output the baseband OFDM signal; and
an external modulator configured to output the output light by modulating the carrier light in which the spectrum width is increased based on the baseband OFDM signal.

12. The apparatus of claim 1, comprising:
an optical source configured to output the carrier light based on a wavelength or a frequency band pre-allocated to the optical transmission apparatus;
an optical feedback unit configured to increase the spectrum width of the carrier light to be greater than a default value by reflecting, to the optical source, a portion of the carrier light;
a digital signal processor configured to output the baseband OFDM signal;
a reflective modulator configured to output the output light by modulating the carrier light in which the spectrum width is increased based on the baseband OFDM signal; and
an optical circulator configured to change a path of the carrier light in which the spectrum width is increased to allow the carrier light in which the spectrum width is increased to be incident to the reflective modulator, and change a path of the output light output from the reflective modulator to output the output light.

13. The apparatus of claim 1, comprising:
a photodiode configured to receive the output light from the optical transmission apparatus;
a filter configured to filter a dithering tone from the output light; and
a demodulator configured to demodulate the baseband OFDM signal from the output light from which the dithering tone is filtered.

14. An optical line terminal (OLT), comprising:
an optical reception apparatus configured to receive an output light from an optical transmission apparatus of an optical network unit (ONU) and demodulate a baseband orthogonal frequency division multiplexing (OFDM) signal from the received output light;
an optical source generator configured to output a carrier light in which a spectrum width is increased to be greater than a default value based on a wavelength or a frequency band pre-allocated to the optical transmission apparatus of the ONU; and
an optical circulator configured to transmit the output light received from the optical transmission apparatus of the ONU to the optical reception apparatus and transmit, to the optical transmission apparatus of the ONU, the carrier light output from the optical source generator and in which the spectrum width is increased.

15. The OLT of claim 14, wherein the optical source generator comprises:
a tone generator configured to generate a dithering tone; and
an optical source configured to generate a carrier light based on a wavelength or a frequency band pre-allocated to the optical transmission apparatus of the ONU, increase the spectrum width of the carrier light using the dithering tone, and output the carrier light in which the spectrum width is increased to be greater than the default value.

16. The OLT of claim 14, wherein the optical source generator comprises:
an optical source configured to output a carrier light based on a wavelength or a frequency band pre-allocated to the optical transmission apparatus of the ONU; and
a phase modulator configured to output the carrier light in which the spectrum width is increased by performing phase modulation on the carrier light.

17. The OLT of claim 14, wherein the optical source generator comprises:
an optical source configured to output a carrier light based on a wavelength or a frequency band pre-allocated to the optical transmission apparatus of the ONU; and
an optical feedback unit configured to increase the spectrum width of the carrier light to be greater than the default value by reflecting a portion of the carrier light to the optical source.

18. The OLT of claim 14, further comprising:
an optical transmission apparatus of the OLT to load a downlink signal onto a carrier light in a frequency band for downlink transmission and output the carrier light loaded with the downlink signal; and
an optical coupler configured to combine the carrier light loaded with the downlink signal and the carrier light in which the spectrum width is increased and transmit the combined carrier light to the optical circulator, and
wherein the optical circulator is configured to transmit the combined carrier light to the optical transmission apparatus of the ONU.

19. The OLT of claim 14, wherein the optical transmission apparatus of the ONU comprises:
a digital signal processor configured to output the baseband OFDM signal;
a reflective modulator configured to output the output light by modulating the carrier light in which the spectrum width is increased to be greater than the default value based on the baseband OFDM signal; and
an optical circulator configured to output the output light to the OLT by receiving, from the OLT, the carrier light in which the spectrum width is increased to be greater than the default value, allowing the carrier light in which the spectrum width is increased to be incident to the reflective modulator, and changing a path of the output light output from the reflective modulator.

20. The OLT of claim 14, wherein the optical transmission apparatus of the ONU comprises:
a digital signal processor configured to output the baseband OFDM signal; and
an external modulator configured to output the output light by receiving, from the OLT, the carrier light in which the spectrum width is increased to be greater than the default value and modulating the carrier light in which the spectrum width is increased based on the baseband OFDM signal.
